(19) United States
(12) Patent Application Publication
(10) Pub. No.: US 2019/0061102 A1
(43) Pub. Date: Feb. 28, 2019

(54) WATER-JET CUTTING METHOD, WATER-JET CUTTING MACHINE AND WORKPIECE HOLDER

(71) Applicant: Siemens Aktiengesellschaft, Munchen (DE)

(72) Inventor: Christoph Sammler, Berlin (DE)

(21) Appl. No.: 15/767,277

(22) PCT Filed: Sep. 14, 2016
(86) PCT No.: PCT/EP2016/071676

§ 371 Date: Apr. 10, 2018

(30) Foreign Application Priority Data
Oct. 30, 2015 (DE) 102015221273.4

(51) Int. Cl. B24C 1/04; B26F 3/00

(52) U.S. Cl. CPC B24C 1/045; B26F 3/008

(57) ABSTRACT

A water-jet cutting method, in which a workpiece is cut on a water-jet cutting machine by using a water jet, which can contain abrasive particles, wherein, during the cutting machining, the workpiece to be cut is held on at least two holding surfaces, which are arranged on opposite sides of a passage opening defining a predetermined cutting machining area is provided. The disclosed further relates to a workpiece holder for a water-jet cutting machine and to a water-jet cutting machine having such a workpiece holder.

### CROSS-REFERENCE TO RELATED APPLICATIONS

This application claims priority to PCT Application No. PCT/EP2016/071676, having a filing date of Sep. 14, 2016, based off of German application No. 102015221273.4 having a filing date of Oct. 30, 2015, the entire contents of both of which are hereby incorporated by reference.

### FIELD OF TECHNOLOGY

The following relates to a water-jet cutting method in which a workpiece is cut on a water-jet cutting machine using a water jet which by choice can contain abrasive particles. Embodiments of the invention also relate to a workpiece holder for a water-jet cutting machine and also to a water-jet cutting machine having such a workpiece holder.

### BACKGROUND

In the case of water-jet cutting, it is a separation process using geometrically undefined cutting edges, in which the workpiece is cut using a focused water jet of small diameter at pressures of up to 6000 bar and exit velocities of up to 1000 m/s. For increasing the cutting power, abrasive particles can be admixed with the water jet in order to also be able to split harder materials. An essential advantage of water-jet cutting exists in the fact that during the machining the workpiece barely heats up, which is why structural changes of the workpiece material do not occur.

Water-jet cutting machines, in addition to the nozzle which forms the water jet, normally have a water-filled jet collecting tank on which is arranged in most cases a cover of grid-like design as a workpiece holder. For the positioning and/or fixing of the workpiece on the cover, provision can be made for stops or clamping devices which in most cases are fastened directly on the cover.

A significant disadvantage of known water-jet cutting methods, which are implemented on conventional water-jet cutting machines, exists in the fact that the water jet which cuts through the workpiece also cuts into the cover of grid-like design, which is why this has to be exchanged at regular time intervals, which is accompanied by corresponding time consumption and high costs. This disadvantage comes into effect especially when during the course of a serial production the nozzle is moved on always the same travel paths. A further disadvantage exists in the fact that during impingement of the water jet upon the cover reflected jet effects occur, as a result of which the surface of the workpiece lying on the cover can be damaged. During the cutting of fiber-reinforced materials, the disadvantage of these being prone to delamination during impingement of the water jet also comes into effect, which can result in a high scrap rate. This applies especially when the fiber-reinforced materials have very delicate structures and a small fiber bedding-in length. It is also seen to be disadvantageous that traditional water-jet cutting machines, for lack of adequately reproducible workpiece positioning, can be integrated into complex production process chains only to a limited extent, especially during the machining of small, already available workpiece geometries in the form of milled grooves or the like.

### SUMMARY

Starting from this known art, an aspect relates to creating a water-jet cutting method, a workpiece holder for a water-jet cutting machine and a water-jet cutting machine having such a workpiece holder, which at least partially remedies the previously described disadvantages.

invention further aspect creates a water-jet cutting method of the type referred to in the introduction which is characterized in that during the cutting machining the workpiece to be cut is seated on at least two seating surfaces which are arranged on opposite sides of a through-opening which defines a predetermined cutting machining area. According to embodiments of the invention, the workpiece to be cut is therefore not laid on a cover of grid-like design but seated on at least two oppositely disposed seating surfaces between which the cutting machining area is defined. Accordingly, the seating surfaces cannot be damaged during the workpiece machining, providing the machining is carried out within the predetermined cutting machining area.

According to one embodiment of the water-jet cutting method according to embodiments of the invention, the workpiece is positioned prior to the cutting machining in a predetermined position and clamped in this position, wherein the positioning of the workpiece is carried particularly with reference to a coordinate system of the water-jet cutting machine. A positioning and clamping of the workpiece has the advantage that this cannot move during the cutting machining, as a result of which a high degree of precision is achieved during the cutting machining. The positioning of the workpiece with reference to a coordinate system of the water-jet cutting machine enables a reproducible arrangement of the workpiece relative to the water-jet cutting machine, which is why integration of the water-jet cutting method into complex production process chains is possible without any problem.

The workpiece to be cut, during the cutting machining, is advantageously held at least between a lower exchangeable plate and an upper exchangeable plate forming a sandwich arrangement, wherein the sandwich arrangement is pressed in the direction of the seating surfaces. In this case, the lower exchangeable plate preferably lies upon the seating surfaces. In the case of such a sandwich arrangement, the workpiece to be cut is covered on both sides by the exchangeable plates, as a result of which damage to the surfaces of the workpiece, especially a delamination, is generally prevented. On the one hand, the scrap rate is correspondingly reduced. On the other hand, workpieces which up to now could not be easily machined by means of water-jet cutting, like in particular fiber-reinforced materials, to name just one example, can also be cut without any problem.

The lower exchangeable plate is preferably produced from a foamed material, especially from a foamed, closed cell, hydrophobic plastic. Accordingly, the workpiece cannot be damaged during the clamping of the sandwich arrangement.

The upper exchangeable plate is preferably produced from a non-foamed plastic, for example from polystyrene or PMMA, as a result of which very good machining results are achieved despite the covering of the workpiece.

According to one embodiment of the water-jet cutting method according to embodiments of the invention, at least the lower exchangeable plate is positioned prior to the cutting machining in a predetermined position, especially with reference to a coordinate system of the water-jet cutting machine. Accordingly, the lower exchange plate and the workpiece can be aligned relative to each other without any problem.

According to a variant of the water-jet cutting method according to embodiments of the invention, in which a section of the workpiece is cut out, the separating cut is divided into two sections, wherein after carrying out the first separating cut section and prior to carrying out the second separating cut section at least the lower exchangeable plate, but preferably both the lower exchangeable plate and the upper exchangeable plate, is/are rotated or replaced by another exchangeable plate of similar type. In this way, on the one hand the effect of the cut out section of the workpiece possibly together with the cut out section of the exchangeable plates being able to fall through the through-opening defined between the seating surfaces is prevented. On the other hand, manufacturing inaccuracies, which otherwise frequently occur during the separating of the last remaining web region, are minimized.

Advantageously, a support bracket butts against the underside of the workpiece or against the underside of the sandwich arrangement with supporting effect during the cutting machining. Owing to such a support bracket, the stability of the workpiece or of the sandwich arrangement during the machining is improved.

For achieving the object referred to in the introduction, embodiments of the present invention also creates a workpiece holder for a water-jet cutting machine, especially for implementing a method according to embodiments of the invention, which is characterized in that the workpiece holder has at least two seating surfaces which are arranged on opposite sides of a through-opening which defines a predetermined cutting machining area. The advantages which accompany the use of such seating surfaces instead of covers of grid-like design have already been explained in the introduction.

Preferably, provision is made for at least one clamping unit, which can be transferred into at least one clamping position, in which it presses a workpiece, held in the workpiece holder, downward in the direction of the seating surfaces. Such a clamping device serves for the vertical clamping of the workpiece.

According to one embodiment of the present invention, the clamping unit has a pressure plate of frame-like design which is arranged above a workpiece to be clamped at least in the clamping position. By means of such a pressure plate of frame-like design, a uniform surface pressure can be exerted upon the workpiece, which is very beneficial to machining accuracy.

Provision is advantageously made for first stops which are designed for the positioning of a workpiece, held in the workpiece holder, within a horizontal plane. Owing to such stops, a reproducible positioning of the workpiece inside the workpiece holder can be ensured. This is particularly advantageous when the workpiece has to be re-clamped during the machining and/or in the course of a serial production.

The first stops advantageously define at least two stop surfaces which are arranged at a predetermined angle to each other, especially at an angle of 90°. Owing to such stop surfaces, a very simple construction is achieved.

According to one embodiment of the present invention, the predetermined angle can be altered. Accordingly, the position of the stop surfaces can be variably adapted to differently shaped workpieces.

Provision is preferably made for a clamping device which is designed for the purpose of pressing a workpiece, held in the workpiece holder, against the first stops. In this way, fixing of the workpiece within the horizontal plane is achieved.

The clamping device advantageously has at least two clamping elements which can be moved forward and backward in different directions to each other, especially in directions which are perpendicular to each other, as a result of which a simple construction is achieved.

According to one embodiment of the present invention, provision is made between the seating surfaces and the first stops for second stops which are arranged in an offset manner in relation to the first stops. Such second stops serve for the positioning of a lower exchangeable plate if such a plate is used.

The second stops preferably define at least two stop surfaces which are arranged at a predetermined angle to each other, especially at an angle of 90°, and which in particular extend parallel to stop surfaces of the first stops, wherein the first stop surfaces preferably project inward over the second stop surfaces in the direction of the through-opening. Therefore, a simple construction is achieved.

According to one embodiment of the present invention, provision is made for a support bracket which extends at least partially beneath the seating surfaces and has a free end which is arranged on a common level with the seating surfaces. The advantages of such a support bracket have already been explained previously.

The support bracket advantageously has a U-shaped section, wherein oppositely disposed legs of the U-shaped section, of which one defines the free end, preferably have a length of at least 50 cm. The U-shaped section is advantageous to the effect that regions of the support bracket, which are arranged at a distance from the free end in the horizontal plane, cannot be hit by the water jet during the machining of a workpiece. The preferred length of the legs of at least 50 cm ensures that the arc-shaped region of the U-shaped section, during the machining of a workpiece in a water-jet cutting machine, dip far enough into the jet collecting tank and is correspondingly protected against damage.

For achieving the object referred to in the introduction, embodiments of the present invention also create a water-jet cutting machine having a workpiece holder according to the invention.

### BRIEF DESCRIPTION

Some of the embodiments will be described in detail, with reference to the following figures, wherein like designations denote like members, wherein:

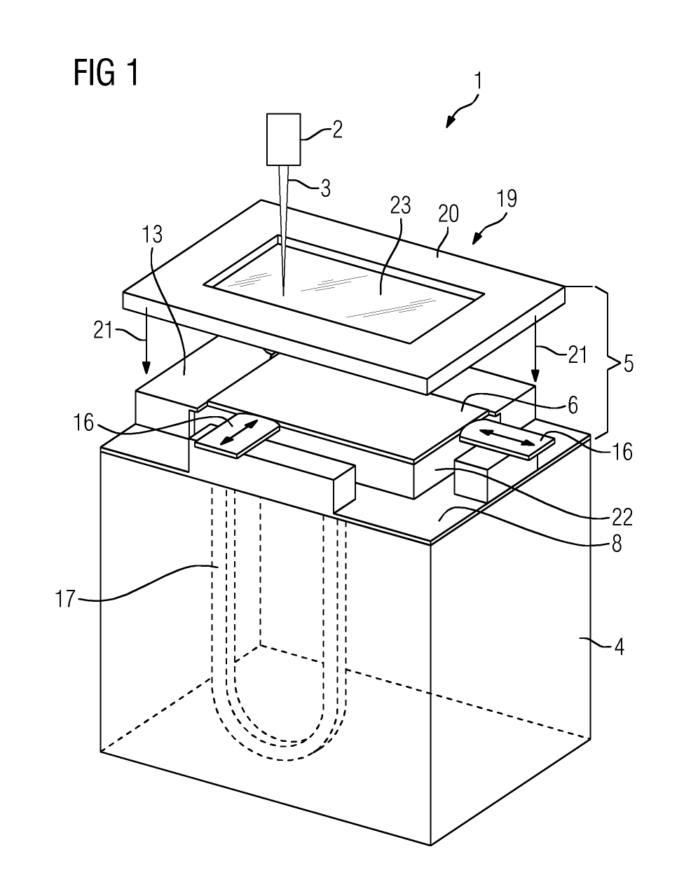

FIG. 1 shows a schematic perspective view of a section of a water-jet cutting machine according to an embodiment of the present invention, wherein a jet collecting tank of the water-jet cutting machine is shown transparently for better representation;

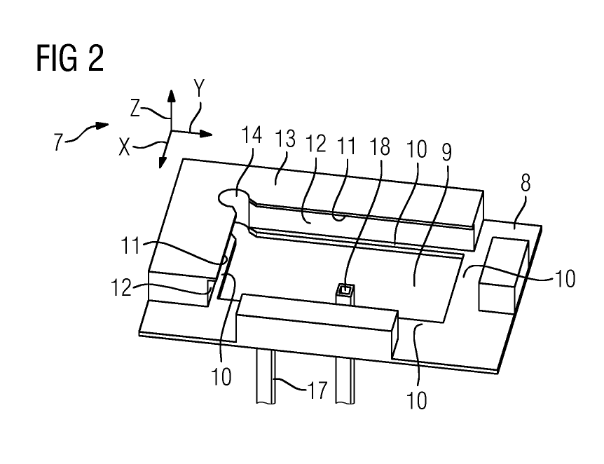

FIG. 2 shows a schematic perspective partial view of a workpiece holder of the water-jet cutting machine shown in FIG. 1;

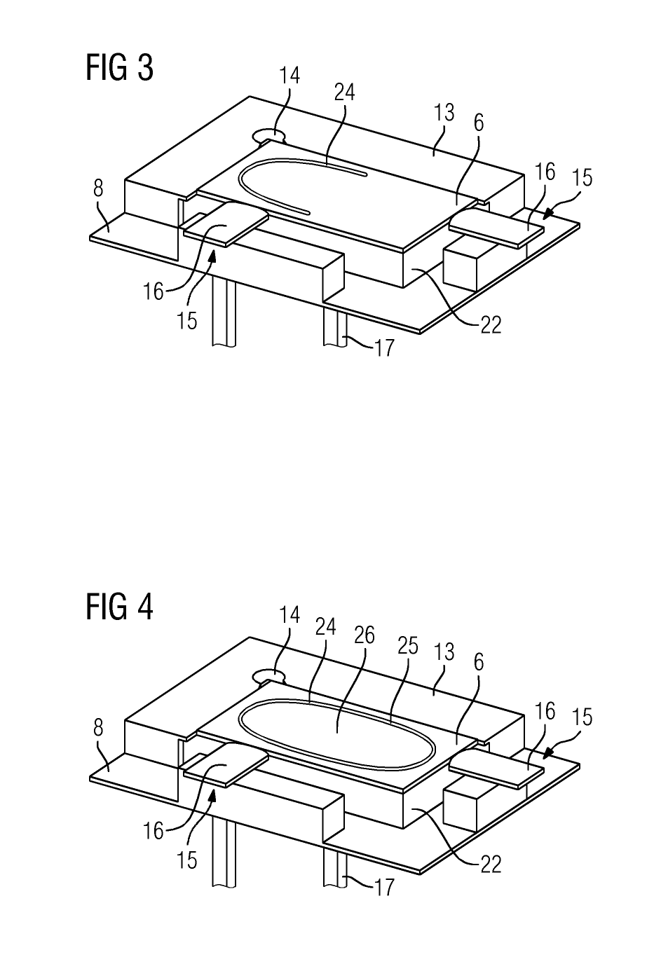

FIG. 3 shows a perspective partial view of a workpiece holder shown in FIG. 2, in which are held a lower exchangeable plate and a workpiece; and

FIG. 4 shows a schematic perspective partial view of the arrangement shown in FIG. 3 in a state in which the workpiece has been machined.

### DETAILED DESCRIPTION

The figures show a section of a water-jet cutting machine 1 according to an embodiment of the present invention or components of this. The water-jet cutting machine 1 comprises a nozzle 2, connected to a high-pressure pump, not shown in more detail, which serves for the purpose of forming a water jet 3 which is generated by the high-pressure pump. The water-jet cutting machine also comprises a jet disperser, in the present case in the form of a parallelepipedal, water-filled jet collecting tank 4. Above the jet collecting tank 4 provision is made for a workpiece holder 5 which is designed in such a way that a workpiece 6 to be machined can be positioned and fixed on it with reference to a machine-dedicated coordinate system 7 which is defined by X-, Y- and Z-axes.

The workpiece holder 5 comprises a baseplate 8 of frame-like design with a rectangular through-opening 9 which defines a predetermined cutting machining area for machining a workpiece 6 which is held in the workpiece holder 5. Formed on the upper side of the baseplate, at the side of the through-opening 9, are four seating surfaces 10 which in the present case lie opposite each other in pairs and directly adjoin the through-opening 9. For the positioning of a workpiece 6, provision is made for first stop means which in the present case define two first stop surfaces 11 which are arranged on a common level and define an angle of 90° within the X-Y plane. Between the baseplate 8 and the first stop means provision is also made for second stop means which in the present case define two second stop surfaces 12 which extend parallel to the first stop surfaces 11 and also include an angle of 90° within the X-Y plane. Both the first stop surfaces 11 and the second stop surfaces 12 are formed on a separate L-shaped body 13 in this embodiment, wherein the regions of the first stop surfaces 11 which are adjacent to each other as well as those of the second stop surfaces 12 are separated from each other by a groove 14 which extends through the body 13 in the Z-direction and is basically in the shape of an arc in cross section. The workpiece holder 5 also comprises a clamping device 15, in the present case arranged on the upper side of the baseplate 8, with two clamping elements 5 which are arranged at the same height as the first stop surfaces 11 and on sides of the through-opening 9 opposite these, wherein one of the clamping elements 16 can be moved forward and backward in the X-direction and other of the clamping elements 16 can be moved forward and backward in the Y-direction, as is indicated by arrows. Mounted on the underside of the baseplate 8, in a manner to pivot around a Z-axis, is a support bracket of U-shaped design, the free end 18 of which engages in the through-opening 9 and terminates flush with the upper side of the baseplate 8 in the Z-direction. The oppositely disposed legs of the U-shaped section of the support bracket 17 in the present case have a length of at least 50 cm.

Above the baseplate 8 and the components which are mounted on this, provision is made for a clamping unit 19 which can be transferred into at least one clamping position in which it presses a workpiece 6, held in the workpiece holder, downward in the direction of the seating surfaces 10. The clamping unit 19, which also forms a part of the workpiece holder 5, has a pressure plate 20 of frame-like design which extends within an X-Y plane and by means of pressure elements, not shown in more detail, can be moved upward and downward in the Z-direction, as is indicated by the arrows 21.

For arranging a workpiece 6 in the workpiece holding device 5, in a first step a lower exchangeable plate 22 is laid upon the seating surfaces 10 and brought into contact with the second stop surfaces 12, as a result of which a defined positioning of the lower exchangeable plate 22 is effected. The lower exchangeable plate 22 in the present case is of parallelepipedal shape and formed from a hard foam, wherein the thickness of the lower exchangeable plate 22 is chosen to be significantly thicker than that of the workpiece 6 and the dimensions of the lower exchangeable plate 22 in the X- and Y-directions are slightly larger than that of the workpiece 6. In a further step, the workpiece 6 is laid on the lower exchangeable plate 22 and brought into contact with the first stop surfaces 11, with which an alignment of the workpiece 6 is associated. After this, the clamping elements 16 are moved in the direction of the workpiece 6 until these press the workpiece 6 tightly against the first stop surfaces 11 and correspondingly fix it. In a subsequent step, an upper exchangeable plate 23, which in the present case is produced from non-foamed polystyrene, is laid upon the workpiece 6, wherein the dimensions of the upper exchangeable plate 23 in the X- and Y-directions correspond in the main to those of the lower exchangeable plate 22 and the thickness is significantly smaller than that of the lower exchangeable plate 22. In a further step, the pressure plate 20 is lowered and pressed onto the upper exchangeable plate 23 until the entire sandwich arrangement, which is formed from the lower exchangeable plate 22, the workpiece 6 and the upper exchangeable plate 23, is clamped with a predetermined pressure between the seating surfaces 10 and the pressure plate 20. After that, the support bracket 17 is positioned beneath the lower exchangeable plate 22, especially in a position in which cutting is not to be carried out. Now, the machining of the workpiece can be carried out, wherein the water jet 3, which discharges from the nozzle 2 and with which by choice abrasive particle can be admixed, cuts through the entire sandwich arrangement and is then collected in the jet collecting tank 4. FIGS. 3 and 4 show by way of example the workpiece 6 after the execution of a first separating cut section 24 and after the execution of a second separating cut section 25 which are carried out in order to cut out an area 26 from the workpiece 6. The workpiece 6 which is shown in FIG. 3 is already provided with the first separating cut section 24. After the execution of this first separating cut section 24 and prior to the execution of the second separating cut section 25, at least the lower exchangeable plate 22 is rotated or replaced by an exchangeable plate 22 of a similar design. Preferably, however, both the lower exchangeable plate 22 and the upper exchangeable plate 23 are rotated or replaced by other exchangeable plates 22, 23 of a similar design. In this way, the effect of the cut out area 26 of the sandwich construction being able to fall into the jet collecting tank 4 after producing the second separating cut section 25 is prevented. The machining accuracy is also increased since the workpiece 6 during separation remains clamped in and positioned. The previously described design of the workpiece holder 5 ensures the reproducible positioning of the workpiece 6 despite the exchange of the exchangeable plates 22, 23.

Although the invention has been fully illustrated and described in detail by means of the preferred exemplary embodiments, the invention is not limited by the disclosed examples and other variations can be derived therefrom by the person skilled in the art without departing from the extent of protection of the invention. This applies particularly with regard to the specific embodiment and number of the seating surfaces 10, the stop surfaces 11 and 12, the clamping elements 16 and the clamping unit 19. So, for example the angles which include the seating surfaces 10 as well as the stop surfaces 11 can differ from 90° or be variably adjustable. Also, the seating surfaces 10 and 11 do not have to be formed on a separate body 13.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A water-jet cutting method, in which a workpiece is cut on a water-jet cutting machine using a water jet which can contain abrasive particles, comprising: during the cutting machining, seating the workpiece to be cut on at least two seating surfaces which are arranged on opposite sides of a through-opening which defines a predetermined cutting machining area.

2. The water-jet cutting method as claimed in claim 1, comprising positioning the workpiece prior to the cutting machining in a predetermined position and clamped in this position, wherein the positioning of the workpiece is carried out with reference to a coordinate system of the water-jet cutting machine.

3. The water-jet cutting method as claimed in claim 1, wherein during the cutting machining the workpiece to be cut is held at least between a lower exchangeable plate and an upper exchangeable plate, forming a sandwich arrangement, and in that the sandwich arrangement is pressed in the direction of the seating surfaces, wherein the lower exchangeable plate preferably lies on the seating surfaces.

4. The water-jet cutting method as claimed in claim 3, wherein the lower exchangeable plate is produced from a foamed material, wherein the foamed material comprises foamed plastic.

5. The water-jet cutting method as claimed in claim 3, wherein the upper exchangeable plate produced from a non-foamed plastic.

6. The water-jet cutting method as claimed in claim 3, wherein at least the lower exchangeable plate is positioned prior to the cutting machining in a predetermined position, especially with reference to a coordinate system of the water-jet cutting machine.

7. The water-jet cutting method as claimed in claim 3, wherein a section of the workpiece is cut out, wherein the separating cut is divided into two separating cut sections, and after executing the first separating cut section and prior to executing the second separating cut section, at least the lower exchangeable plate, but preferably both the lower exchangeable plate and the upper exchangeable plate, is/are rotated or replaced by another exchangeable plate of similar type.

8. The water-jet cutting method as claimed in claim 1, wherein a support bracket butts against the underside of the workpiece or against the underside of the sandwich arrangement with supporting effect during the cutting machining.

9. A workpiece holder for a water-jet cutting machine, wherein the workpiece holder has at least two seating surfaces which are arranged on opposite sides of a through-opening which defines a predetermined cutting machining area.

10. The workpiece holder as claimed in claim 9, wherein provision is made for at least one clamping unit which can be transferred into at least one clamping position in which it presses a workpiece, held in the workpiece holder, downward in the direction of the seating surfaces, wherein the clamping unit preferably has a pressure plate of frame like design which at least in the clamping position is arranged above a workpiece to be clamped.

11. The workpiece holder as claimed in claim 9, wherein provision is made for first stops which are designed for the positioning of a workpiece, held in the workpiece holder, within a horizontal plane, wherein the first stops preferably define at least two first stop surfaces which are arranged at a predetermined angle to each other, especially at an angle of 90°, wherein the predetermined angle can especially be altered.

12. The workpiece holder as claimed in claim 11, wherein provision is made for a clamping device which is designed for the purpose of pressing a workpiece, held in the workpiece holder, against the first stops, wherein the clamping device preferably has at least two clamping elements which can be moved forward and backward in different directions to each other, especially in directions which are perpendicular to each other.

13. The workpiece holder claimed in either of claim 11, wherein between the seating surfaces and the first stops provision is made for second stops which are arranged in an offset manner in relation to the first stops, wherein the second stops preferably define at least two stop surfaces which are arranged at a predetermined angle to each other, especially at an angle of 90°, and which extend especially parallel to stop surfaces of the first stops, wherein the first stop surfaces preferably project inward over the second stop surfaces in the direction of the through-opening.

14. The workpiece holder as claimed claim 9, wherein provision is made for a support bracket which extends at least partially beneath the seating surfaces and has a free end which is arranged on a common level with the seating surfaces, wherein the support bracket preferably has a U-shaped section, wherein oppositely disposed legs of the U-shaped section, of which one defines the free end, preferably have a length of at least 50 cm.

15. A water-jet cutting machine having a workpiece holder as claimed in claim 9.
